(19) United States
(12) Patent Application Publication
(10) Pub. No.: US 2001/0048797 A1
(43) Pub. Date: Dec. 6, 2001

(54) Fully indentifiable optical fiber assemblies

(76) Inventors: Saskia I. Van Dijk, Maastricht (NL); Aylvin J. Dias, Maastricht (NL); Jacob L. De Haas, Sittard (NL); Mark G. Tilley, Glen Ellyn, IL (US); Timothy P. Reichert, Downers Grove, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/804,952

(22) Filed: Mar. 13, 2001

Related U.S. Application Data
(60) Provisional application No. 60/189,327, filed on Mar. 14, 2000.

(51) Int. Cl. G02B 6/22; G02B 6/44

(52) U.S. Cl. 385/114; 385/128

(57) ABSTRACT

The present invention relates to a radiation-curable composition comprising, in the uncured state, at least one monomer or oligomer having a radiation-curable functional group which can form free radicals in the presence of actinic radiation, a photoinitiator for said monomer or oligomer present in an amount sufficient to effect radiation cure of said monomer or oligomers and a contrasting agent which causes an observable change in the cured composition upon exposure to energy from a high energy tunable light source.

The invention further relates to an optical fiber ribbon assembly comprising said radiation curable composition and including energy-induced indicia, and to a process for importing indicia to an optical fiber ribbon assembly.

### FIELD OF THE INVENTION

The present invention relates to an optical fiber ribbon assembly comprising a plurality of coated optical fibers and a matrix material for binding the coated optical fibers. The ribbon and the optical fibers are identifiable by a combination of color coding and marking of the coatings, the matrix material or the matrix material and coatings. The invention also relates to a process for marking a radiation-cured composition via a high energy tunable light source, e.g., laser irradiation, and to a radiation-curable optical fiber composition.

### BACKGROUND OF THE INVENTION

Optical cables generally comprise a plurality of coated optical fibers, often in the form of a series of optical fiber assemblies, e.g., flat ribbon assemblies. Optical fibers are generally made of glass, although the use of plastic fibers is also known. Such optical cables are widely used for multi-channel signal transmission in telecommunications and cable television. However, after ribboning and cabling of fiber, the individual strands of fiber must still be readily accessible and distinguishable from each other so they can be accurately identified during, for example, installation and repair. Cable geometry and/or color coding can be used to distinguish and identify individual fibers and assemblies in a complex cable. Such color coding is commonly done by manufacturers of optical fiber, ribbon assemblies and cable in order to differentiate individual components, but such coloring does not assist in identifying the manufacturer of any of the components. As such, color coding is for a completely different purpose than marking with indicia such as for example corporate logos, bar codes, product numbers or the like which serve to identify the specific manufacturer.

Color coding of a fiber can be done advantageously with either a thin ink layer (<30 microns) which is placed over the coated fiber before ribboning and cabling or by using a colored outer primary coating. Hereinafter both systems will be referred to as a (colored) fiber coating. It is also possible to color code in a number of other capacities, such as for example coloring primary coatings and applying a clear coating as the secondary coating. Further, conventional primary/secondary coating methods either wet on wet or wet on dry can be used. Also, color coding by applying the ink in lines, dashes, dots, concentric circles, bands and the like, or other effective color coding means is known.

Optical glass fibers are generally coated with two superposed radiation-cured coatings, which together form a primary coating. The coating which is directly in contact with the fiber is called the inner primary coating and the overlaying coating is called the outer primary coating. The inner primary may also be called the primary coating; then, the outer primary coating is called the secondary coating. Both definitions are used interchangeably.

The inner primary coating is usually a relatively soft coating providing environmental protection to the glass fiber and resistance, inter alia, to the well-known phenomenon of microbending. Microbending in the coated fiber can lead to attenuation of the signal transmission capability of the coated fiber and is therefore undesirable. The outer primary coating(s), which is on the exposed surface of the coated fiber, is typically a relatively harder coating designed to provide a desired resistance to physical handling forces, such as for example those encountered when the fiber is cabled.

Tape-like optical fiber ribbon assemblies are prepared by embedding a plurality (typically 4 to 12) of individually color coded fibers parallel to each other in a supporting matrix material which, like the inner and outer primary coatings, is also radiation-curable to maximize production speed. The matrix material can encase the color coded optical glass fiber or the matrix material can edge-bond the glass fibers together. Cure of the matrix material occurs during the ribboning stage after the fibers have been color coated. In another assembly design, a number of ribbons, e.g., 2, 4 or 8 fiber ribbons, are bundled together in a plane configuration with a second matrix material. In a further design, a number of ribbons are stacked, and are bundled by applying a further matrix material (i.e., bundling) material. The radiation-curable composition used for binding fibers or bundling ribbons together, will hereinafter be referred to as matrix material. Also, other types of fiber assemblies are known, in which fibers are not aligned parallel. Within the context of this application the term optical fiber ribbon assembly is used for all optical fiber assemblies.

In order to accommodate the growing need for rapid data-transfer, there is a tendency to increase the number of fibers in a ribbon assembly, and, in turn, to increase the number of assemblies in a cable. For identification purposes, it is desirable to increase the number of different colors for the fibers, and it is also desirable to distinguish the various ribbon assemblies, e.g., by coloring the matrix materials. Such color multiplication substantially increases costs of production and production logistics. A supplement to color coding is to print marks on the fibers and assemblies, e.g., by using ink-jet techniques. EP-A-0581680, for example, discloses a ribbon of optical fibers in which the ribbon and its individual fibers can be identified by applying a distinct number of annular markings on the surface of a protective coating layer via an inkjet system.

Furthermore, there is also a growing need in the industry to improve the traceability of optical cable systems and their components, especially in view of product responsibility. It would be advantageous if not only the producer but also production data of individual ribbons and fibers could be identified, e.g., in case of malfunctioning of an optical transmission system. For this purpose, a coding on optical fibers and ribbon assemblies, representing, e.g., the manufacturer, coating supplier, lot-numbers, and the like could be applied during production. Ink-jet printing techniques may be used for such purposes, but it has not been done in the art to date.

There are several drawbacks and problems associated with the use of ink-jet printing during production of optical fibers and fiber assemblies. Firstly, optical fiber production speeds are very high and are continuously being improved. For ink-jet printing, drying of the ink, whether it is a solvent-based system or a UV-curable system, may be insufficient, causing running of the ink. Apart from this, the resolution that can be obtained from ink-jet printing is in general insufficient for legible or machine-readable markings to be made on individual fibers. Also the use of additional chemicals and/or curing stages is not favored. In the case of solvent-based inks, solvent may migrate into the coating layers and affect properties, which can result in undesirable optical transmission losses. Finally, ink-jet markings are not permanent, as they show limited scratch and abrasion resistance.

Laser marking of plastic materials as such is known in the art. Laser marking on the outer protective layer of a cable, including an optical cable, is described in U.S. Pat. No. 5,111,523. According to this publication a mark is obtained by partly subliming the outer protective layer, which is of thermoplastic material. A similar approach is described in WO-93/07628. Here also a mark is made by burning through an outer layer of thermoplastic fluoropolymer with a laser beam, on, e.g., an electrical wire or optical fiber co-extruded with multiple coaxial layers. A disadvantage of such ablative methods is that this type of marking is known to be scratch-sensitive. Moreover, such ablative methods can not be applied on coatings on optical fibers, because of danger of optical signal losses.

Laser marking of the outer layer of an optical cable without damaging the material is described in DE-A-19849543. This publication describes a cable having a protective jacket comprising at least one layer of extruded thermoplastic resin, preferably polypropylene, containing a pigment that changes color under influence of electromagnetic radiation, like microwave-, IR- or UV-radiation and lasers. This publication does not disclose or suggest that a laser-marking technique might be applied to optical fibers or fiber assemblies that are coated with radiation-cured compositions.

There is, therefore, a need for an optical cable system that is fully identifiable on the level of assemblies and on the level of individual fibers, for both installation and repair purposes, as well as for product traceability. There is also a need for a process to apply markings and codings that are compatible with the high production speeds encountered in optical fiber production. There is also a need for markings that do not adversely affect fiber optical properties, and that are not removable.

### SUMMARY OF THE INVENTION

The present invention provides optical fibers and optical fiber ribbon assemblies which are permanently marked with energy-induced indicia of choice. The optical fiber, the matrix material of the ribbon assembly or any combination thereof, comprise a radiation-curable coating composition which includes a contrasting agent which, upon exposure to a high energy tunable light source such as for example a laser, causes an observable change in the coating. The change observed is the selected indicia desired, and may include, for example, alpha numeric characters, symbols, designs or the like. The energy from the tunable light source is matched to the contrasting agent so that the contrasting agent itself undergoes an observable change, such as a change in color, charring or degradation, or the contrasting agent causes an observable change to its immediate environment. In either case, the desired indicia becomes imprinted on the fiber coating or the matrix material and the marking is permanent, resistance to scratching or rubbing off or the like, and is observable.

As used herein, the terms observable and observable change mean a change that is visibile to the human eye, a change that is machine or light readable, or any combinations thereof. Also, as used herein, the term high energy tunable light source means any tunable light source capable of emitting a wavelength of light having sufficient energy to cause the contrasting agent to create the observable change in the optical fiber coating or matrix material. By way of example, and not in limitation, a high energy tunable light source includes a laser. Other high energy tunable light sources are also useful in the practice of the invention. The invention will be described herein with respect to a laser as the tunable light source.

The present invention provides novel matrix materials which include a contrasting agent which can cause an observable change under the influence of energy from a high energy tunable light source, such as for example a laser. The present invention also provides a novel optical fiber ribbon assembly which includes energy-induced indicia. The ribbon assembly comprises a plurality of coated optical fibers and a matrix material for binding said plurality of coated optical fibers together, wherein at least one of the coated fibers or the matrix material is a radiation-cured coating composition comprising at least one contrasting agent that can cause an observable change when exposed to energy from a high energy tunable light source, such as for example a laser.

The present invention also provides an optical fiber coated with a radiation-cured coating composition comprising at least one contrasting agent which can cause an observable change under influence of energy from a high-energy tunable light source, such as for example a laser. The fiber can be, e.g., laser-marked and be made identifiable.

The present invention provides a coating which can be used to uniquely identify optical fiber in an optical fiber ribbon assembly without the need of further increasing the number of different colors commonly used for color coating. The present invention also provides an optical fiber ribbon assembly in which each fiber has a unique code that represents a predetermined indicia, such as, for example, production data.

Matrix material made in accordance with the present invention can be used to provide an optical fiber ribbon assembly in which the ribbon is identifiable, e.g., in an optical cable, without having to introduce a large number of colors for the matrix material.

Use of the present invention also provides a telecommunications system comprising fully identifiable optical fiber ribbon assemblies. Other objects and advantages of the invention will be apparent to those of ordinary skill in the art.

### DETAILED DESCRIPTION OF THE PREFERRED EMBODIMENTS

In one aspect, the present invention provides a radiation-curable composition comprising, in the uncured state, at least one monomer or oligomer having a radiation-curable functional group which can form free radicals in the presence of actinic radiation, a photoinitiator for said monomer or oligomer present in an amount sufficient to effect radiation cure of said monomer or oligomers and a contrasting agent which causes an observable change in the cured composition upon exposure to energy from a high energy tunable light source, such as for example laser irradiation. The observable change can be, for example, a change in color, a change in state, e.g., from a dye to a pigment, change due to degradation, or the like.

The radiation curable composition of the present invention can be used in several applications. It can be used as coating material on a substrate, like for example, plastics (polycarbonate, polymethacrylate, polystyrene, polyester, polyolefin, epoxy resins, melamine resins, triacetyl cellulose resins, ABS resins, AS resins, norbornene resins, etc.), metals, woods, papers, glasses, and slates or as an adhesives for for example digital versatile discs (DVD). Preferably the compositions are used as coating for glass fibers or as matrix material for glass fibers.

Surprisingly it has been found that laser markings of good contrast and high resolution can be made on optical fiber coatings comprising radiation-sensitive colorants, which coatings have already undergone exposure to radiation, especially UV-radiation, during their curing step.

Within the context of this invention a contrasting agent can be a colorant that can change color under influence of energy from the tunable light source, such as for example laser irradiation. Such a colorant is understood to mean a substance, such as for example an inorganic or organic pigment or dye, or a pigment or dye precursor, that loses its color by exposure to energy, such as for example laser radiation (i.e., which for purposes of this application shall be called a bleachable colorant), or changes color, or is a colorless substance that is modified into a colored substance (e.g., a prechromic compound) upon exposure to energy, such as for example laser irradiation. Suitable colorants are preferably thermally stable under conditions of production and use, which is generally less than 100° C., and they are preferably UV-stable. Bleachable colorants, especially bleachable organic pigments are preferred. As discussed previously, contrasting agents that do not themselves undergo a color change, but cause a change in the environment of the contrasting agent are also suitable. For example, a pigment that absorbs energy and causes charring, discoloration or the like to the coating is entirely satisfactory, although preferably, the altered coating does not cause significant changes to the transmission characteristics of the optical fiber. For example, carbon black and (FeCr)₂O₃ are suitable for use in the present invention. The energy, e.g., laser, induced observable change is preferably irreversible, so that non-erasable markings are obtained, although less permanent markings are also suitable and within the scope of this invention.

In a preferred embodiment of the invention the optical fiber ribbon assembly contains a plurality of optical fibers, coated with at least one radiation-cured coating or ink composition comprising at least one contrasting agent that causes an observable change upon exposure to energy from a high-energy tunable light source, such as, for example, colorant that can change color under influence of laser irradiation, which fibers are identifiable by a combination of a colored coating and a laser-mark on their coating. At present, ribbon assemblies generally contain at maximum twelve color coated optical fibers, requiring twelve different colors to adequately distinguish each of the optical fibers from one another. Examples of colors normally used for making ribbon assemblies include: black, white, yellow, blue, red, green, orange, brown, pink, aqua, violet, and gray. By including as colorants for these colored coatings or by including as an additional colorant, colorants that can change color under influence of energy, such as for example laser irradiation, e.g., bleachable colorants, a mark can be made on the colored surface of the fiber by irradiating it with a suitable energy, source, such as, for example, a laser source. The mark can be made by using, for example, a writable laser-beam, by applying matrix dots, or by using a mask. Preferably the laser-irradiation is performed on-line during the cabling production process, after applying and curing the coatings. By repeating the marking every certain fiber length, e.g., in the form of a pattern visible to the naked eye, the colored and laser-marked fiber can be distinguished from a fiber with the same colored coating but without laser-marks. An advantage of applying different markings on different fibers is that the number of distinguishable fibers that can be made and combined into one optical ribbon assembly multiplies, without the need of introducing more differently colored coating compositions. The number of different colors may even be decreased, which would save significant amounts in production and logistical costs. Examples of such markings include (continuous) single or multiple lines along the fiber axis, or short lines, dots, squares, and the like at regular intervals. Other high-energy tunable light sources can be used with equal effect.

In another preferred embodiment of the invention, the energy, e.g., laser, mark applied to the optical fiber represents a unique code, e.g., in the form of a combination of letters and numbers, or a bar code or other encrypted code. The advantage of such marking is that also during later use of the fiber in an optical system, all specific production information of a certain fiber may be linked to the performance of the fiber in practice (product traceability). The energy-induced indicia, e.g., laser-mark, can be legible to the naked eye, but the coding can also be made so small that magnification would be required, or more preferred, that the coding can be read by an automated instrument, e.g., a bar-code reader. The laser marking process provides the option of having a coding that details product traceability, in an encoded fashion that can only be read by machine, or it can be read by both machine/instrument as well as the human eye.

In a specific embodiment, an optical ribbon assembly comprising a plurality of coated optical fibers and a matrix material binding said plurality of coated optical fibers together, the fibers are coated with colored radiation-cured coating compositions comprising at least one contrasting agent, that causes an observable change upon exposure to energy from a high-energy tunable light source, such as, for example, colorant that can change color under influence of energy, such as for example laser irradiation, and the matrix material is a radiation-cured composition that is transparent to the laser radiation. The advantage of this construction is that the ribbon assembly is identifiable by energy-induced indicia, e.g., by a laser-mark provided on the surfaces of fibers in the assembly. In order to secure legibility, the marking preferably extends over the surface of at least two fibers, more preferably over at least four fibers, and even more preferably over at least six fibers. The marking can be in the form of a company name or logo, a product or serial number, bar code, or the like, or any combination of markings, as desired.

It is also possible that the fibers contained in the above optical assembly bear themselves a laser-mark for individual identifiability.

In another preferred embodiment, the optical fiber ribbon assembly is identifiable by energy-induced indicia, such as for example by a laser-mark, directly on the surface of the matrix material. In this embodiment, the matrix material is a radiation-cured composition comprising at least one contrasting agent, that causes an observable change upon exposure to energy from a high energy tunable light source, such as, for example, colorant that can change color under influence of energy, such as for example laser irradiation. Carbon black and (FeCr)₂O₃ are additional examples of suitable contrasting agents. The optical fibers contained in the ribbon may be conventionally color coded fibers, or marked fibers according to the invention. The energy-induced indicia, e.g., laser-mark, can be legible to the human eye, but also machine and/or instrument-readable. Still further, the mark can be designed to cover both human eye legible and/or machine/instrument readable identification. Conversely, the mark can be specifically designed to cover only human eye legible or only machine/instrument readable encoded information, depending on the end user's preference or need. Thus, this technique offers security as well and information revealing indicia.

The invention also provides a process for energy, e.g., laser, marking an optical fiber that is coated with a radiation-cured coating composition comprising at least one contrasting agent that causes an observable change upon exposure to energy from a high energy tunable light source, such as, for example, a colorant that can change color under influence of laser irradiation.

In accordance with the invention, after the colored outer primary coating (secondary coating) or ink composition on the fiber is cured, the fiber is subjected to light from a high energy tunable light source at a wavelength sufficient to allow the contrasting agent to cause an observable change in the coating or ink layer with the desired indicia, such as for example a company identifier including a name, code or the like, or other marking indicia. Preferably, the marking is done with a laser. It is particularly advantageous to carry out the marking process on-line, to avoid additional handling of the fiber. Similarly, the invention provides a process for applying indicia to a ribbon assembly. In that case, the indicia are applied after the ribboning process. Preferably, the marking process is carried out on-line and with a laser.

The high-energy tunable light source suitable for use in the present invention can be any light source capable of emitting light at a wavelength which will allow the contrasting agent to cause an observable change. In one aspect of the invention, the wavelength of the light from the tunable light source and the wavelength at which the contrasting agent absorbs light is preferably matched in order to obtain the desired marking. More particularly, it is desirable to select the wavelength of the tunable light source that will be absorbed by the contrasting agent that will cause the observable change to make the desired mark. Other wavelengths are likewise possible so long as an observable change is realized.

Preferably, a laser is used as the tunable light source. The laser apparatus that can be used for the laser-marking method according to the invention is not specifically limited. Suitable lasers preferably emit light of wavelength in the UV/VIS or the IR region. Suitable lasers include UV-excimer lasers, Ar-ion lasers, Nd:YAG lasers, CO₂-lasers, dye-lasers, and OPO wavelength-adjustable lasers. Most preferred are lasers emitting light in the UV/VIS or near-IR spectrum. The laser radiation may be of the continuous- or of the pulsed-type, the pulsed-type lasers being preferred. Suitable are lasers that can provide an energy density of approximately 0.05-50 J/cm². The contrasting agents, including the colorants, should not display the desired observable change, e.g., change of color during radiation curing, i.e., during exposure to actinic radiation with energy densities of typically 0.05-2 J/cm². Although the wavelength of radiation is also an important parameter, depending on the colorants, the ratio of energy densities of the laser irradiation used for marking over the actinic radiation used for curing is in general preferably at least 2, more preferably at least 4, and even more preferably at least 8. A ratio of energy densities below 2 may give a faint mark that may not be very easily readable. To prevent damaging of the coating, the maximum ratio is preferably 200, more preferably 100, and even more preferably 50.

Wavelengths of 355 nm from a UV-laser Nd:YAG frequency tripled, 532 nm from an Nd:YAG frequency doubled, and 1064 nm from an Nd:YAG not frequency doubled laser have been used successfully to laser-mark optical fiber in ribbon assemblies. In a preferred embodiment of the process according to the invention, an Nd:YAG laser with frequency doubling; emitting light of wavelength of 532 nm and energy densities in the range of from about 0.1 to 20 J/cm² has been used satisfactorily.

The laser-mark can be made with a laser with a so-called moving or writing beam, but preferably a stationary beam is used in combination with a mask. Other examples of lasers suitable for laser-marking UV-curable coatings for optical fiber include beam-steered CO₂ lasers, mask CO₂ lasers, and dot matrix CO₂ lasers all working with a wavelength of 9.3-10.6 microns.

Laser-marking is preferably performed during the production of the coated optical fiber, that is after radiation-curing of the colored secondary coating or the ink layer. This gives the advantage of having a simple process.

The invention also relates to a process for energy, e.g., laser, marking an optical fiber ribbon assembly. In a preferred embodiment of the present invention, a laser-mark is made on the ribbon assembly, by irradiating with laser light in the shape of the mark, through a transparent matrix material, onto the surfaces of the coatings of fibers contained in the assembly. In keeping with the invention, the fibers are coated with a radiation-cured coating composition comprising at least one contrasting agent that causes an observable change upon exposure to energy from a high-energy tunable light source, such as, for example, colorant that can change color under influence of laser irradiation, without visually damaging the fiber coatings. In order to make a legible mark, the marking is preferably extended over the surface of at least two fibers, more preferably over at least four fibers, and even more preferably over at least six fibers. The marking can be in the form of any desired indicia, including by way of example, a company name or logo, a product or serial number, a coding, or any combination thereof, etc.

In another embodiment of the process according to the invention, a laser-mark is directly applied on the surface of the matrix material of an optical fiber ribbon assembly. The matrix material is a radiation-cured composition comprising at least one contrasting agent as described herein, such as, for example, colorant that can change color under influence of laser irradiation and the surface of the matrix material is irradiated with laser-light in the shape of the mark. The marking can be any indicia, and can be, for example, in the form of text, such as for example a company or product name, numbers, such as for example a product-, serial- or lot-number, or in the form of graphical representation or symbol, such as a company logo or an encrypted coding, or any combination thereof. For visual identification the mark is preferably of such size that it is easy legible; for other purposes it may be as small as allowed by the attainable resolution and machine readability. The marking may represent some unique, optionally encrypted, coding relating to production details or the like.

The laser-marking of an optical fiber ribbon assembly can be done off-line in a separate step, but it is preferably performed on-line during the production of the assembly, that is after radiation-curing of the matrix material.

The energy density of the laser irradiation used for marking is from about 0.1 to about 20 J/cm², and preferably from about 1 to about 10 J/cm². Preventing damage to the matrix material is less critical than in case of the optical fiber coatings. This means for example, that for laser-marking of an assembly also a marking mechanism in which some local surface ablation or foaming occurs is allowable. Preferably, the matrix material is not visibly damaged. It is preferred that a laser-marked ribbon according to the invention yields a product that shows less than 0.1 dB/km difference in attenuation as compared to a product using an unmarked ribbon.

It is desirable to select a contrasting agent or combination of contrasting agents and laser to provide not only an observable indicia or mark, but also to provide a satisfactory rate of laydown of the indicia at line speeds at or exceeding the line speed at which fiber and/or ribbon assemblies are formed. Typically, for matrix materials and ribbon assemblies, the rate of laydown of the indicia is approximately 5 indicia per meter. This corresponds to a line speed of approximately 200 to 500 meters/minutes. It is contemplated that the indicia that is laid down is the entire indicia, not just a portion, but the indicia laydown, indicia laydown rate and line speed will vary with the size and complexity of the indicia.

The invention also relates to telecommunications systems that comprise an optical fiber or a fiber assembly that comprises a colorant that changes color in response to laser irradiation and that is identifiable by laser marking or by a combination of color coding and laser-marking.

Also provided by the present invention is a radiation-curable optical fiber coating composition comprising, in the uncured state, (a) at least one monomer or oligomer having a radiation-curable functional group, (b) a photo-initiator system for said monomer or oligomer present in an amount sufficient to effect radiation cure of said monomer or oligomer in the presence of actinic radiation, wherein the composition also comprises (c) at least one contrasting agent as described herein, such as a colorant that can change color under influence of laser radiation. Further, the fiber preferably includes laser-induced indicia. The coating composition can also include a reactive diluent and other additives as well.

This composition if suitably formulated can be used as an outer primary coating, a single coating, as an ink composition or as a matrix material or bundling material. Preferably, the radiation-curable coating is a matrix material or bundling material. Compositions suitable for the present invention are generally known within the skill of the art and are described for example in U.S. Pat. Nos. 4,624,994, 4,629,285, 4,682,851, 4,782,129, 4,794,133, 4,806,574, 4,849,462, 5,219,896 and 5,336,563. Colored coating compositions are also specifically described in e.g., DE-A-4007519 and EP-B-0473643. All these publications are incorporated herein by reference.

Suitable radiation-curable oligomers or monomers having at least one functional group capable of polymerization when exposed to actinic radiation radiation-curable are now well known and within the skill of the art. Commonly, the radiation-curable functionality used is ethylenic unsaturation, which can be polymerized through radical polymerization or cationic polymerization. Specific examples of suitable ethylenic unsaturation are groups containing acrylate, methacrylate, styrene, vinylether, vinyl ester, N-substituted acrylamide, N-vinyl amide, maleate esters, and fumarate esters. Preferably, the ethylenic unsaturation is provided by a group containing acrylate, methacrylate, or styrene functionality. Preferably, at least about 80 mole %, more preferably, at least about 90 mole %, and most preferably substantially all of the radiation-curable functional groups present in the oligomer are acrylate or methacrylate.

A suitable radiation-curable composition essentially consists of from about 1 to about 80 weight % of at least one radiation-curable oligomer. Preferred amounts of the radiation-curable oligomer are from about 20 to about 70% by weight, based on the total weight of the composition. A mixture of mono-, di-, tri-, tetra-, and higher functionalized oligomers can be used to achieve the desired balance of properties, wherein the functionalization refers to the number of radiation-curable functional groups present in the oligomer.

The oligomers usually comprise a carbon-containing backbone structure to which the radiation-curable functional group(s) are bound. Examples of suitable carbon-containing backbones include polyethers, polyolefins, polyesters, polyamides, and polycarbonates. The size of the carbon-containing backbone can be selected to provide the desired molecular weight. The number average molecular weight of the oligomer is usually between about 500 to about 10,000, preferably between about 500 to about 7,000, and most preferably between about 1,000 to about 5,000.

For example, the carbon-containing backbone of the oligomer can comprise aromatic groups and ring-opened epoxy groups or alkoxy groups. The oligomer can be represented by, for example:

R—Ar—R; or R-L-Ar-L-R

where R is a radiation-curable functional group,

Ar is an aromatic group containing moiety, and

L is a linking group.

Examples of suitable linking groups include alkoxy or ring opened epoxy such as ethoxy, propoxy, butoxy, and repeat units thereof. L can also be a urethane or urea linking group.

The aromatic groups can be, for example, derived from bisphenol units, such as bisphenol A. A preferred oligomer is a diglycidyl ether derivative of bisphenol A to which acrylate functional groups have been bound. A commercially available example of such an oligomer is Ebecryl® 3700 (UCB) or CN-120 (Sartomer), the latter having a molecular weight of about 1300, and when cured has a Tg of about 65° C.

Another example of a preferred oligomer is a trifunctional polyether or polyester having a molecular weight of about 500 to about 5000. A preferred example of a trifunctional oligomer is the commercially available polyurethane triacrylate Ebecryl® 264, which has a molecular weight of about 2000 and when cured a Tg of about 42° C.

The radiation-curable compositions may also contain a reactive diluent which is used to adjust the viscosity. The reactive diluent can be a low viscosity monomer having at least one functional group capable of polymerization when exposed to actinic radiation. This functional group may be of the same nature as that used in the radiation-curable monomer or oligomer. Preferably, the functional group present in the reactive diluent is capable of copolymerizing with the radiation-curable functional group present on the radiation-curable monomer or oligomer. A mixture of reactive diluents can also be used. When a mixture of reactive diluents is used, generally, each reactive diluent has a molecular weight of less than about 550 and a viscosity of less than about 500 mPa.s.

A suitable radiation-curable composition essentially consists of from about 1 to about 80 wt. % of at least one radiation-curable diluent. Preferred amounts of the radiation-curable diluent from about 5 to about 60 wt. %, more preferably from about 10 to about 50 wt. %, based on the total mass of the composition.

The reactive diluent can be a monomer or mixture of monomers having an acrylate or vinyl ether functionality and a C4-C20 alkyl or polyether moiety.

Particular examples of such reactive diluents include: hexylacrylate, 2-ethylhexylacrylate, isobornylacrylate, decylacrylate, laurylacrylate, stearylacrylate, 2-ethoxy-ethylacrylate, laurylvinylether, 2-ethylhexylvinyl ether, N-vinyl formamide, isodecyl acrylate, isooctyl acrylate, N-vinyl caprolactam, N-vinylpyrrolidone, and the like.

Another type of reactive diluent that can be used is a compound having an aromatic group. Particular examples of reactive diluents having an aromatic group include: ethyleneglycolphenylether-acrylate, polyethyleneglycolphenylether-acrylate, polypropyleneglycolphenylether-acrylate, and alkyl-substituted phenyl derivatives of the above monomers, such as polyethyleneglycolnonylphenyletheracrylate.

The reactive diluent can also be a compound having two or more functional groups capable of polymerization. Particular examples of such monomers include:

C2-C18 hydrocarbon-dioldiacrylates,

C4-C 18 hydrocarbondivinylethers,

C3-C 18 hydrocarbon triacrylates, and the polyether analogues thereof, and the like, such as

1,6-hexanedioldiacrylate,

trimethylolpropanetri-acrylate,

hexanedioldivinylether,

triethylene-glycoldiacrylate,

pentaerythritol-triacrylate,

ethoxylated bisphenol-A diacrylate, and

tripropyleneglycol diacrylate.

Preferably, alkoxylated aliphatic polyacrylates are used, such as ethoxylated hexanedioldiacrylate, propoxylated glyceryl triacrylate or propoxylated trimethylolpropanetriacrylate.

A single photo initiator or two or more photo initiators can be included in the coating composition. In order to increase curing speeds a combination of photo initiators may be advantageously used, especially if colorants are present. Suitable photo initiators are well known and within the skill of the art, and include e.g., free-radical photo initiators.

Free-radical photo initiators are generally divided into two classes according to the process by which the initiating radicals are formed. Compounds that undergo uni-molecular bond cleavage upon irradiation are termed Type I photo initiators.

If the excited state photo initiator interacts with a second molecule (a co-initiator COI) to generate radicals in a bimolecular reaction, the initiating system is termed a Type II photo initiator. Examples of suitable α-cleavage, homolytic free-radical photo initiators (Type I) are benzoin derivatives, methylolbenzoin and 4-benzoyl-1,3-dioxolane derivatives, benzilketals, α,α-dialkoxyacetophenones, α-hydroxy alkylphenones, α-aminoalkylphenones, acylphosphine oxides (under which also bisacylphosphine oxides), acylphosphine sulphides, halogenated acetophenone derivatives, and the like. Commercial examples of suitable Type I photoinitiators are benzildimethyl ketal or 2,2-dimethoxy-1,2-diphenylethanone, 1-hydroxy-cyclohexyl-phenyl ketone as the active component, 2-hydroxy-2-methyl-l-phenylpropan-1-one as the active component, 2-methyl-1-[4-(methylthio)phenyl]-2-morpholino propan-1-one, 2-benzyl-2-dimethylamino-1-(4-morpholinophenyl)-butan-1-one as the active component, poly {2-hydroxy-2-methyl-1-[4-(1-methylvinyl)phenyl]propan-1-one blend of poly {2-hydroxy-2-methyl-1-[4-(1-methylvinyl)phenyl]propan-1-one} and 2-hydroxy-2-methyl-1-phenyl-propan-1-one, blend of poly {2-hydroxy-2-methyl-1-[4-(1-methylvinyl)phenyl]propan-1-one}, 2,4,6-trimethylbenzoyldiphenylphosphine oxide and methylbenzophenone derivatives, acylphosphine oxides such as 2,4,6-trimethylbenzoyl diphenyl phosphine oxide, bis (2,4,6-trimethylbenzoyl)-phenyl-phosphine-oxide, 25:75% blend of bis (2,6-dimethoxybenzoyl)2,4,4-trimethylpentyl phosphine oxide and 2-hydroxy-2-methyl-1-phenyl-propan-1-one, and the like. Also mixtures of Type I photoinitiators can be used. For colored (e.g. pigmented) systems, 2-methyl-1-[4-(methylthio)phenyl]-2-morpholino propan-1-one is preferred.

Examples of suitable Type-II (hydrogen abstraction) photo initiators are aromatic ketones such as benzophenone, xanthone, derivatives of benzophenone (e.g., chlorobenzophenone), blends of benzophenone and benzophenone derivatives, e.g., a 50/50 blend of 4-methyl-benzophenone and benzophenone), Michler's Ketone, Ethyl Michler's Ketone, thioxanthone and other xanthone derivatives like isopropyl thioxanthone, benzil, anthraquinones (e.g., 2-ethyl anthraquinone), coumarine, and the like. Chemical derivatives and combinations of these photoinitiators can also be used.

Type-II photoinitiators generally are used together with an amine synergist. Preferably, the amine synergist is chosen from the group consisting of a monomer tertiary amine compound, an oligomer (polymer) tertiary amine compound, a polymerizable amino acrylate compound, a polymerized amino acrylate compound and mixtures thereof.

The amine-synergist may include tertiary amine compounds, such as alkanol-dialkylamines (e.g., ethanol-diethylamine), alkyldialkanolamines (e.g., methyldiethanolamine), trialkanolamines (e.g., triethanolamine), and ethylenically unsaturated amine-functional compounds including amine-functional polymer compounds, copolymerizable amine acrylates, and the like. The ethylenically unsaturated amine compounds may also include dialkylamino alkyl(meth)acrylates (e.g., diethylaminoethylacrylate) or N-morpholinoalkyl-(meth)acrylates (e.g., N-morpholinoethyl-acrylate).

Preferably, the total amount of photo initiators present is between about 0.10 wt. % and about 20.0 wt. % relative to the total amount of the coating composition. More preferably, the total amount is at least about 0.5 wt. %, particularly preferred, at least about 1.0 wt. %, and most preferred, at least about 2.0 wt. %. Moreover, the total amount is preferably less than about 15.0 wt. %, more preferably, less than about 10.0 wt. %, and particularly preferred, less than about 6.0 wt. %.

A colorant that can change color under influence of laser radiation includes any colored substance, like an inorganic or organic pigment or dye, that completely or partly loses its color (e.g., a bleachable colorant) or changes its color by exposure to laser radiation. It can also be a colorless substance that is modified by exposure to laser radiation into a colored substance (e.g., a prechromic compound). Examples of contrasting agents are disclosed in U.S. Pat. No. 6,022,905, the disclosure of which is incorporated by reference herein. Suitable colorants should be thermally stable under conditions of production and use, which is generally less than 100° C., and be UV-stable, especially under UV-curing conditions. Bleachable organic pigments are preferred. In view of the thickness of the fiber coatings, the mean particle size of pigments is preferably not more than about 1 micron. It will also be appreciated that nanoparticles or nano colorants having a particle size of from at least 0.1 to about 0.2 μm are also useful in the practice of the invention. Examples of colorants that are bleachable by laser energy include, but are not limited to, Cromophtal Red G® and Cromophtal Brown® (Ciba Geigy).

The laser-induced color change is preferably irreversible, so that non-erasable markings are obtained. Photochromic colorants, generally defined as colorants that can show a reversible color change, would therefore if used, not be preferred for permanent identification. Suitable contrasting agents include titanium dioxide treated mica, mixed metal oxides, dyes, organic pigments, and other organic materials such as polyvinyl chloride, polycarbonate, chlorinated paraffins and the like.

Specific examples of suitable inorganic pigments which can function as the contrasting agent, including some that can change color under the influence of laser radiation, include titanium dioxides, zinc oxide, antimony trioxide, zinc sulfide, lithopones, basic lead carbonate, basic lead sulfate or lead silicate, bismuth oxide silicate, as well as metal oxides such as iron oxides, chromium oxides, nickel antimony titanate, chromium antimony titanate, manganese blue, manganese violate, cobalt blue, cobalt chromium blue, cobalt nickel grey, ultramarine blue, lead chromates, lead sulfochromates, molybdate orange, molybdate red, as well as metal sulfides such as cadmium sulfide, arsenic disulfide, antimony trisulfide, cadmium sulfoselenides, calcium silicates, zirconium silicates, and also carbon blacks or graphite. Inorganic pigment that irreversibly change color at threshold temperatures are disclosed in U.S. Pat. No. 4,861,620, the disclosure of which pertaining to such pigments is hereby incorporated by reference. Exemplary of such pigments are cobalt compounds, such as cobalt oxalate, cobalt formate and cobalt phosphate, potassium cobalticnitride, copper compounds, such as copper oxalate, nickel compounds, such as nickel oxalate, lead compounds, bismuth oxalate, and a mixture of nickel oxalate and cobalt oxalate. Zeolite, cordierite, mica, kaolin, chinaclay talc and the like can be used also. Preferred inorganic pigments are chosen from the group consisting of titanium dioxide, titanium dioxide treated mica, antimony trioxide, iron-containing oxides and bismuth-containing oxides.

In addition, inorganic substrates coated with a material that can function as a contrasting agent can also be used. For example, metal oxide coated substrates, such as for example pearlescent micas can be satisfactorily employed in the practice of the invention. Other mica-based laser energy absorbing additives can be also be used. The laser energy absorbing additives comprise mica in flake, platelet or pearl form, preferably having a particle size of less than 15 microns. Suitable mica-based additives for use with Nd:YAG lasers include Iriodin® LS 820 and LS 825 (EM Industries).

Examples of organic pigments or dyes that can change color under the influence of laser radiation include monoazo, bisazo, aromethine, azine, methine, anthraquinone, indanthrone, pyranthrone, flavanthrone, benzanthrone, phtalocyanine, perinone, perylene, dioxazine, thioindigo, isoindoline, isoindolinone, quinacridone, pyrrolopyrrole, quinophtalone or xanthene compounds, as well as metal complexes of e.g., azo, azomithine, or methine compounds. Specific examples of organic pigments include, but are not limited to Barium red 1050® (Cook son), Filamid yellow R®, Filamid red GR®, Heliogen green K8730®, Heliogen blue K6911 D®, LISA yellow 57Y®, LISA red 61R®, (Bayer), and the like. Specific examples or organic dyes suitable for use in the practice of the invention include, but are not limited to, Macrolex green G®, Macrolex orange 3G®, Macrolex violet 3R®, Macrolex yellow 3G®, Macrolex fluorescent yellow 10GN® (Ciba Geigy), Fluorescent yellow 3R®, Orange 3B® (Bayer), and the like. Also, a group of colorants designated as “latent pigments” can suitably be used. Examples of such compounds are described in U.S. Pat. No. No. 5,484,493 and U.S. Pat. No. 5,561,232, the disclosures of which are incorporated herein by reference.

Examples of colorless compounds that obtain color under the influence of laser radiation include prechromic compounds like the cyclopentadienone derivatives described in WO-96/37369, or some of the above-mentioned latent pigments.

The colorants can be present in the composition in an amount that provides coloration that is visible without magnification to facilitate identification of the individual colored optical glass fiber, or ribbon. The amount of the colorant should not be so great as to significantly reduce the cure speed of the coating composition or result in other undesirable affects. Examples of suitable amounts of colorants have been found to be of from about 0.5 to about 25 wt. %. Generally, the amount is less than 25 wt. %, preferably less than about 20 wt. %, more preferably less than about 10 wt. %, based on the total weight of the composition. More preferably, the amount of colorant is from about 0.1 to about 10 wt. % and even more preferably from about 0.5 to about 5 wt. %. Additionally, examples of suitable amounts of contrasting agent are from about 0.05 wt. % to about 25 wt. % of the total composition.

Also mixtures or colorants can be used, both mixtures of different colorants that can change color under the influence of laser radiation, as well as mixtures of colorants that can change color under the influence of laser radiation with normal colorants. An advantage of mixtures is that any color can be obtained, and that also the color that is obtained after laser-radiation can be influenced. For example, by combining a blue and a yellow colorant a green colored coating can be obtained, on which a blue colored marking can be obtained by selectively bleaching the yellow colorant with suitable laser radiation, but a yellow marking by selective bleaching of the blue colorant.

Another advantage of using mixtures of colorants that can change color under the influence of laser radiation is that multi-colored markings can be produced, e.g, by multiple irradiating with lasers emitting light of different wavelengths. Such a technique is, for example, disclosed by EP-B-08286 13.

Also, other colorants that do not change color under the influence of laser irradiation can be included in the radiation-curable compositions according to the invention. Any inorganic or organic colorant that is suitable for making radiation-curable coating or ink compositions can be used in the present invention.

Preferably, the colorant used in the coating composition of the present invention is an organic pigment. The pigment can be present in the composition in an amount that provides coloration that is visible without magnification to facilitate identification of the individual colored optical glass fiber. One skilled in the art is able to form any color as desired by combining different pigments. Preferably, the pigment has a mean particle size of not more than about 1 micron. The particle size of commercially available pigments can be lowered by milling if necessary.

Also, dyes that do not change color under the influence of laser irradiation can be used for coloring. To prevent leaching of dyes, one can advantageously use a dye that chemically, photochemically or physically interacts with one of the components of the curing composition.

Titanium dioxide treated mica pigments are beneficial in the practice of the invention. The pigments decrease the threshold energy required to produce an observable mark and prevent penetration of the laser deep within the coating. The combination of pigments, either organic or inorganic or both, combined with the mica additives has been found to enhance contrast of the laser mark.

Other additives which can be used in the radiation-curable carrier system include, but are not limited to, lubricants, wetting agents, antioxidants, stabilizers, and other colorants that do not change color under the influence of energy-induced, e.g., laser, irradiation. The selection and use of such additives is within the skill of the art.

For use on coated optical glass fibers in ribbon assemblies, a release agent can be added to the coating to allow easy access to the individual fibers by separating the matrix material from the coating, usually called break-out. Suitable release agents include silicones, silicone acrylates, fluorocarbon oils or resins and the like. Also, other types of material can be incorporated if they successfully produce a sufficient change in surface energy to allow the break-out process to successfully occur. If present, the coating composition for coating optical fibers used in ribbon assemblies comprises about 0.1 to about 20 wt. %, more preferably about 0.1 to about 10 wt. % of a suitable release agent, based on the total mass of the composition.

For providing good thermal and oxidative, and color stability a stabilizer package may be employed. The stabilizer package can comprise an antioxidant, a secondary antioxidant, a UV-light stabilizer and/or a UV absorber. The amount of each of the compounds of the stabilizer package used is not critical, and can be readily determined by a person skilled in the art by experimentation. In general, the amount of each component, if used, is in the range of, for example, about 0.01 to 7 wt. %, and preferably about 0.1 to 1.5 wt. %.

Antioxidants which can be included in the coating composition include, for example, secondary amines, and phenol- and hindered phenol-derivatives. A preferred antioxidant is a hindered phenol, like thiodiethyl bis-(3,5-di-t-butyl-4-hydroxy phenyl) propionate. Secondary antioxidants that can be included in the coating composition include, for example, ailphatic thiols, disulfides and phosphites. Hindered amine light stabilizers (HALS) can be used as inhibitors of photo-oxidation. Other UV light-stabilizers include benzophenones and benzotriazoles.

Radiation-cure of optical fiber coating can be cured with radiation sources which have characteristic emission outputs which will vary depending on the radiation source. Examplary radiation sources can be obtained from, for example, Fusion UV Systems Inc. or Iwasaki Denki Co. For example, so-called “D-lamps” and “H-lamps” can be used as a radiation source, wherein the D lamp is more rich in longer wavelength ultraviolet light emissions than the H lamp. A typical ultraviolet radiation source (e.g., medium pressure arc lamp) used in industrial production often has major emission lines near the 260, 300, 313, and 366 nm ranges, or more generally at about 250-270 nm, at about 290-320 nm, and at about 360-380 nm. In addition, there can be a line at about 390-410 nm. The characteristic bulb output used in the present invention can be measured by conventional methods or obtained from the supplier of the radiation source. Preferably the, optionally colored, coating composition of the present invention is cured by irradiation with both an H and a D lamp.

Colored coating compositions preferably are cured with sufficient energy to have less than 15% unreacted acrylate unsaturation. Suitable irradiation energy values are 0.05-2 J/cm², preferably 0.1-1.5 J/cm². Values below 0.5 J/cm² are particularly preferred.

The invention will now be further explained by way of the following examples, without being limited thereto.

### EXAMPLE 1

Commercially available matrix material type 950-706 supplied by Desotech Inc, Elgin (MM) was mixed with several colorants using a high shear dispersion mixer. (FeCr)₂O₃ was obtained from Ferro (PK1095). BiₓO_{y}Si_{z} is obtained from DMC² (2077). A cured coating layer of 100 micron thickness was prepared on a glass substrate.

Laser-marking experiments were performed with laser-beam wavelengths of 1064 nm and 532 nm. Conditions used were 99% of maximum power, resolution 300 dpi, pulse-frequency 3 kHz, at laser-beam writing speed of 254 mm/s, with the sample surface 2 mm out of focus (lamp-pumped Nd:YAG laser (1064 nm); diode-pumped Nd:YAG laser (532 nm), both from Haas-Laser, DE.

The results are presented in Table 1.

TABLE 1

| | Sample | | 532 nm |
|---|---|---|---|
| Experiment | Composition | 1064 nm Radiation | Radiation |
| 1 | MM + TiO₂ | Slight marking | Slight marking |
| 2 | MM + 0.1% | Visible marking | Visible marking |
| | Carbon black | | |
| 3 | MM + 0.1% | Good marking with | Good marking with |
| | Ultrafine carbon | high resolution | high resolution |
| | Black | | |
| 4 | MM + 0.1% | Good marking with | Not tested |
| | (FeCr)₂O₃ | high resolution | |
| 5 | MM + 20% | Very good marking | Not Tested |
| | BiₓO_{y}Si_{z} | with high | |
| | | resolution | |
| 6 | MM + 20% | Very good marking | Not Tested |
| | BiₓO_{y}Si_{z} + 5% | With high | |
| | TiO₂ | resolution | |
| Comparative | MM | No marking | No marking |

### EXAMPLE 7

A 12 fiber ribbon which was covered with 0230-171B matrix material. (Cablelite 950-706 matrix material modified with 20% by wt. of the DMC² 2077 (Bismuth Oxide Silicate)) was fed at 100 meter/min on a Nextrom OFC-2 1 machine. Marks were produced on the fiber ribbon at a speed of 300 marks per minute from a Lasertechnics 10.6 u carbon dioxide mask laser (Blazer 6000CE) with a 5 joule/sq cm dose per mark. The marks produced were easily read with good resolution.

While the invention has been described herein with reference to specific or preferred embodiments, it is to be understood that the description is not intended to limit the invention to the embodiments disclosed. On the contrary, it is intended to cover all modifications and alternative forms following within the spirit and scope of the invention.

What is claimed is:

1. An optical fiber ribbon assembly comprising a plurality of coated optical fibers and a cured matrix, wherein at least one of said coated fibers or said matrix is a radiation-curable coating composition comprising, in the uncured state, at least one contrasting agent and said ribbon assembly includes energy-induced indicia.

2. The optical fiber ribbon assembly of claim 1 wherein said matrix material, in the uncured state, includes said contrasting agent.

3. The optical fiber ribbon assembly according to claim 1, wherein at least one of said fibers is coated with a coating which is a radiation-curable coating composition comprising, in the uncured state, at least one contrasting agent, and wherein said fiber is identifiable by a colored coating and energy-induced indicia.

4. The optical fiber ribbon assembly according to claim 1, wherein each fiber has energy-induced indicia representing a unique code.

5. The optical fiber ribbon assembly according to claim 1, wherein said ribbon assembly is identifiable by energy-induced indicia on a plurality of coated fibers, and said indicia extends over at least two fibers.

6. The optical fiber ribbon assembly according to claim 1, wherein at least one of said fibers is identifiable by a colored coating, wherein the matrix material is a radiation-curable coating composition comprising, in the uncured state, at least one contrasting agent, and wherein said ribbon assembly is identifiable by energy-induced indicia on the matrix.

7. An optical fiber ribbon assembly according to claim 1, wherein at least one of said fibers comprises a coating which comprises, in the uncured state, at least one colorant that can change color under the influence of laser radiation, and wherein the energy-induced indicia comprises a laser-mark.

8. An optical fiber ribbon assembly according to claim 1, wherein at least one of the coated fibers is identifiable by a combination of a colored coating and a laser-mark on the coating.

9. The optical fiber ribbon assembly according to claim 1, wherein said matrix is transparent, and wherein said assembly is identifiable by a laser-mark on a plurality of coated fibers, said mark extending over at least two fibers.

10. An optical fiber ribbon assembly according to claim 1, wherein the matrix material is a radiation-cured coating composition comprising, in the uncured state, at least one colorant that can change color under the influence of laser irradiation, and wherein said energy-induced indicia is a laser-mark on the matrix.

11. The optical fiber ribbon assembly according to claim 10, wherein the assembly is identifiable by a combination of a colored matrix and a laser-mark on the matrix.

12. An optical fiber ribbon assembly according to claim 1, wherein said contrasting agent is selected from the group consisting of an inorganic or organic pigment, an inorganic or organic dye, a pigment or dye precursor, a colorless substance that changes into a colored substance upon exposure to energy or combinations thereof.

13. An optical fiber ribbon assembly according to claim 12, wherein the contrasting agent is selected from the group consisting of carbon black, mixed metal oxide, bismuth oxide silicate, titanium dioxide, and titanium dioxide treated mica.

14. A process for imparting indicia to an optical fiber ribbon assembly comprising applying to said ribbon assembly energy from a high energy tunable light source in an amount sufficient to form the indicia on the ribbon assembly, said ribbon assembly comprising a plurality of coated optical fibers and a matrix wherein at least one of said coated fibers or said matrix is a radiation-curable coating composition comprising, in the uncured state, at least one contrasting agent.

15. The process of claim 14 wherein said high-energy tunable light source is a laser.

16. The process of claim 14 wherein said matrix material comprises, in the uncured state, at least one contrasting agent.

17. The process of claim 14, wherein said contrasting agent is selected from the group consisting of an inorganic or organic pigment, an inorganic or organic dye, a pigment or dye precursor, a colorless substance that changes into a colored substance upon exposure to energy or combinations thereof.

18. The process of claim 14, wherein said contrasting agent is selected from the group consisting of carbon black, mixed metal oxide, bismuth oxide silicate, titanium dioxide, and titanium dioxide treated mica.

19. The process according to claim 14, wherein said indicia is formed on the matrix by irradiating the ribbon assembly with laser light in the shape of the mark.

20. The process according to claim 14, wherein said fiber comprises a coating and an optical waveguide, and wherein at least one of said coatings is a radiation-cured coating composition comprising, in the uncured state, at least one contrasting agent.

21. The process according to claim 14, wherein the high energy tunable light source is a laser, and wherein at least one of said fibers comprises a coating which comprises, in the uncured state, at least one colorant that can change color under the influence of laser radiation, and wherein the fiber is identifiable by a laser-mark on the coating.

22. The process according to claim 14, wherein at least one of the coated fibers is identifiable by a combination of a colored coating and a laser-mark on the coating.

23. The process according to claim 14, wherein said high energy tunable light source is a laser, and said matrix material is transparent, and wherein at least two fibers are marked by irradiating with laser light, said mark extending over at least two fibers.

24. The process according to claim 14, wherein the indicia is formed during the production of the ribbon assembly.

25. The process according to claim 14, wherein the ratio of energy densities of the laser irradiation used for marking over the actinic radiation used for curing is between 2 and 200.

26. The process according to claim 25, wherein the ratio is between 4 and 100.

27. A radiation-curable optical fiber coating composition, comprising, in the uncured state:
at least one monomer or oligomer having a radiation-curable functional group which can form free radicals in the presence of actinic radiation,
a photo-initiator system for said monomer or oligomer present in an amount sufficient to effect radiation cure of said monomer or oligomer, and at least one contrasting agent wherein said contrasting agent induces a visible change when subjected to energy from a high-energy tunable light source.

28. The optical fiber coating composition of claim 27, wherein said composition further comprises a compound selected from the group consisting of a reactive diluent, a lubricant, a release agent, an antioxidant, a UV-stabilizer, a colorant that does not change color under the influence of laser radiation, or mixtures thereof.

29. The radiation-curable optical fiber coating of claim 27, wherein said contrasting agent is selected from the group consisting of an inorganic or organic pigment, an inorganic or organic dye, a pigment or dye precursor, or a colorless substance that changes into a colored substance upon exposure to energy, or combinations thereof.

30. The radiation-curable optical fiber coating composition of claim 27, wherein the contrasting agent is selected from the group consisting of carbon black, mixed metal oxide, bismuth oxide silicate, titanium dioxide, and titanium dioxide treated mica.

31. The radiation-curable optical fiber coating composition of claim 27, wherein said coating composition is a matrix material.

32. The radiation-curable optical fiber coating composition of claim 31, wherein said contrasting agent is selected from the group consisting of an inorganic or organic pigment, an inorganic or organic dye, a pigment or dye precursor, or a colorless substance that changes into a colored substance upon exposure to energy or combinations thereof.

33. The radiation-curable optical fiber coating composition of claim 31, wherein the contrasting agent is selected from the group consisting of carbon black, mixed metal oxide, bismuth oxide silicate, titanium dioxide, and titanium dioxide treated mica.

34. The optical fiber coating composition of claim 33, wherein said colorant is a bleachable colorant.

35. An optical fiber coated with at least a radiation-cured coating composition, which comprises, in the uncured state, at least one colorant that can change color under the influence of laser irradiation, and wherein the fiber is identifiable by a laser-mark on the coating.

36. The optical fiber according to claim 35, wherein the fiber is identifiable by combination of a colored coating and a laser-mark on the coating.

37. The optical fiber according to claim 35, wherein the laser-mark represents a unique code.

38. An optical cable comprising at least one fiber or at least one optical fiber assembly according to claim 1.

39. A telecommunications system comprising at least one optical fiber, according to claim 35.

40. A telecommunications system comprising at least one optical fiber ribbon assembly according to claim 1.

41. A telecommunications system comprising at least one optical cable according to claim 38.

42. A telecommunications system comprising at least one energy-induced indicia marked coated optical fiber or at least one energy-induced indicia marked optical fiber ribbon assembly.
